(19) United States
(12) Patent Application Publication
(10) Pub. No.: US 2009/0109979 A1
(43) Pub. Date: Apr. 30, 2009

(54) SYSTEM AND METHOD FOR A MOBILE ACCESS FEMTOCELL

(76) Inventors: Leon Tong, Naperville, IL (US); Paul Harrington, Naperville, IL (US)

Correspondence Address: ADAM K. SACHAROFF;MUCH SHELIST DENENBERG AMENT & RUBENSTEIN, 191 N. WACKER DRIVE, Suite 1800, CHICAGO, IL, 60606-1615, US

(21) Appl. No.: 11/862,042

(22) Filed: Sep. 26, 2007

Related U.S. Application Data
(60) Provisional application No. 60/827,070, filed on Sep. 27, 2006.

(51) Int. Cl. H04L 12/28

(52) U.S. Cl. 370/397

(57) ABSTRACT

A system and method for wireless communication indoors includes a femtocell base station coupled for operable interaction with an in-building router having a virtual private network server client connection embedded therein. A user equipment unit within range of the femtocell base station for interaction therewith cooperates with a virtual private network server, an internet protocol network, and a cellular network to provide improved wireless coverage and quality of service indoors.

### CROSS REFERENCE TO RELATED APPLICATION

This application claims the benefit and priority of U.S. provisional patent application 60/827,070 filed Sep. 27, 2006.

### FIELD OF THE INVENTION

The present invention relates to wireless communications and more particularly to wireless communications indoors having an in-building router interactive with a femtocell base station.

### BACKGROUND OF THE INVENTION

Wireless communications indoors has always been problematic. Wireless users have always had problems using their wireless devices indoors because wireless signals have a difficult time propagating through building walls. For practical reasons, indoor coverage has normally been provided by the outdoor wireless network. The wireless network may even try to compensate for the indoor usage by budgeting for wall attenuation.

Currently, a small sector of the cellular devices have satisfied the indoor coverage by offering a local radio network such as WiFi based on the IEEE 802.11 specifications. This creates a small, in the range of 200 feet, diameter service area. The major drawback of this technique is that the cellular device must contain an 802.11 radio in addition to its normal cellular radio. In addition to the radio requirement, the cellular device must also support call control state machine for an IP network, such as a SIP state machine. Therefore, this approach requires all of today's cellular devices to be replaced with the dual mode devices and the necessary software to run them. A solution that is not very practical.

Another solution is to provide picocell solutions for higher traffic and high worth locations. Unfortunately, the majority of indoor coverage including residential environments are beyond this addressable market.

The present invention solves these problems by allowing existing cellular devices to receive better indoor coverage without any modifications to the device. An advantage to the present invention is that existing cellular devices can be retained, while providing improved utility to the end user in terms of coverage and quality of service indoors. This is accomplished by providing a mobile access femtocell that increases service capacity for the cellular carrier through cell splitting.

### DRAWINGS

FIG. 1 is a block diagram of one exemplary implementation of the present invention.

### DESCRIPTION OF THE EMBODIMENTS

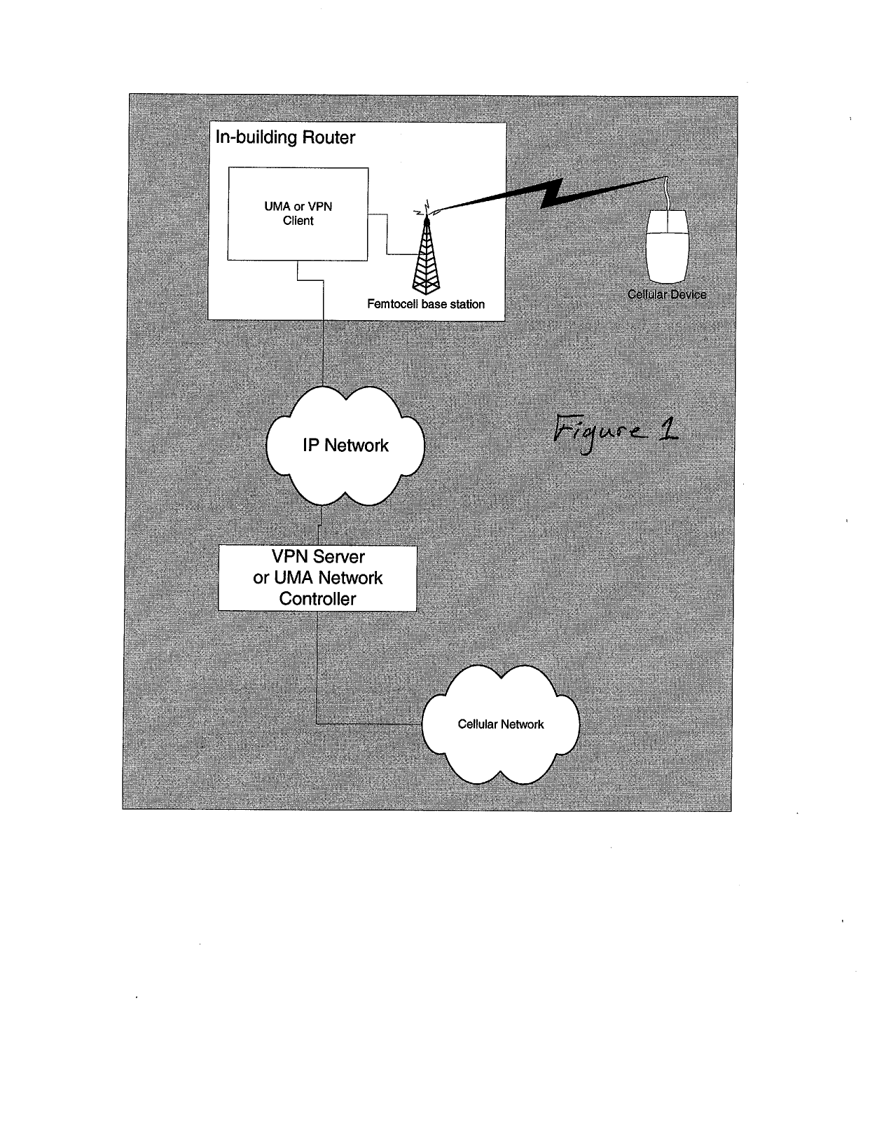

The provision of home, building, or small area GSM, CDMA, WCDMA, and WiMax cellular coverage to user equipment units (UEs) is enhanced by the integration of a femtocell to an in-building router. Referring now to FIG. 1, a femtocell base station 100 is coupled to an in-building router 10 wirelessly or by hardwire. The femtocell base station 100 utilizes the same licensed radio frequencies used by the cellular provider's macrocellular base stations. A UE such as cellular device 20 within range of the femtocell base station 100 will interact therewith just as it would interact with any other cellular base station. The UE can be a cellular telephone, a mobile device, or a laptop which communicates voice and/or data over a radio or air interface.

An unlicensed mobile access (UMA) client is embedded in the in-building router 10 and encapsulates the traffic from the cellular device before sending it to a network-based UMA network controller. The UMA client and UMA controller are implemented in a virtual private network (VPN) client 30 connection that assures communications privacy. The UMA controller will un-encapsulate the UMA packets and send them on to the traditional cellular network 60. All calls and messages will complete as if nothing has changed (even though the network access path changed from the typical cellular access system to the femtocell base station 100 combined with a connection to an internet protocol (IP) network 40 through the VPN server 50.

The present invention has particular relevance to and would be capable of handling GSM, WCDMA, and WiMax cellular technologies.

The present architecture is similar to the way UMA works today, however UMA only works with GSM because the UMA client is embedded in the GSM handset. The UMA VPN tunnel is therefore established between the handset and the UMA controller using a WiFi connection from the handset to a WiFi access point. This requires a WiFi radio in the handset as well as the UMA client software.

In the present embodiment, the UMA client is embedded inside the in-building router. This UMA client would forward the traffic (including for example call control, SMS, and other data traffic protocols well known in the art) from a plurality of cellular devices to a UMA controller via an IPSec VPN. The UMA controller would interwork the content back into the cellular backbone network. The cellular handsets in this case do not require a WiFi radio nor an embedded UMA client.

Although the above described preferred embodiment has been shown and described, the invention is not to be limited to the disclosed embodiment, but on the contrary, is intended to cover various modifications and equivalent arrangements.

We claim:

1. An indoor wireless communication system for communicating with a cellular network comprising:
an in-building router having a virtual private network server client connection embedded therein,
a femtocell base station coupled for operable interaction with said in-building router,
a user equipment unit within range of said femtocell base station for interaction therewith,
a virtual private network server, and
an internet protocol network,
said user equipment unit being capable of operably communicating traffic thereof with said virtual private network server through said internet protocol network, and said virtual private network server being capable of operably communicating traffic thereof with said cellular network.

2. The wireless communication system of claim 1 wherein said virtual private network server client connection services an unlicensed mobile access client or a virtual private network client.

3. The wireless communication system of claim 1 wherein said virtual private network server includes an unlicensed mobile access controller.

4. The wireless communication system of claim 1 wherein said system accommodates at least one or more of the following cellular technologies: GSM, CDMA, WCDMA, and WiMax.

5. The wireless communication system of claim 1 wherein said system accommodates a plurality of user equipment units.

6. A method of operating an indoor wireless communication system for communicating with a cellular network comprising:
maintaining an in-building router having a virtual private network server client connection embedded therein,
coupling a femtocell base station for operable interaction with said in-building router, providing a user equipment unit within range of said femtocell base station for interaction therewith, and
providing a virtual private network server, an internet protocol network, and
a cellular network for interaction with said in-building router, said femtocell base station,
and said user equipment unit wherein said user equipment unit is capable of operably communicating traffic thereof with said virtual private network server through said internet protocol network and said virtual private network server is capable of operably communicating traffic thereof with said cellular network.
